(19) United States
(12) Patent Application Publication
(10) Pub. No.: US 2012/0255890 A1
(43) Pub. Date: Oct. 11, 2012

(54) Portable Water Filter

(76) Inventor: SCOTT L. CUMBERLAND, PLEASANT, CA (US)

(21) Appl. No.: 13/080,516

(22) Filed: Apr. 5, 2011

(51) Int. Cl. B01D 29/17; B01D 35/157

(52) U.S. Cl. 210/136; 210/244; 210/232

(57) ABSTRACT

A portable water filter is disclosed. A portable water filter may filter water that enters through a first opening disposed toward a first end of the filter, where the water may pass through a filter element and exit the filter through a second opening disposed at or toward the first end of the filter. The first opening may be defined in a surface of the filter that is free of openings toward a second end of the filter. As such, when the filter is inserted into an opening or outlet of a bottle, more of the water in the bottle may be filtered and drained with reduced aeration as the first opening in the filter is disposed toward the opening or outlet in the bottle. The portable water filter may enable the flow of water through the filter element to be more uniform across the length of the filter element.

### BACKGROUND OF THE INVENTION

Water filters are commonly used to filter certain materials from tap water or other sources of water. For example, carbon-based filters can filter chlorine, lead, and other undesirable materials found in water. Although filtration solutions for the home and office have been used for years, the demand for portable water filters is increasing as more time is spent on the go and in the car.

Conventional portable water filters, such as the Brita Fill & Go, typically include a replaceable filter cartridge with a flange that sits between the neck of a bottle and the cap. The filter cartridge includes a plurality of slots near the bottom (at the end opposite the flange) that enable water to flow through the filter and cap when the bottle is inverted and squeezed. The filter cartridge also includes a slot near the top (at the same end as the flange) to enable water to flow through the filter and cap after the water level has fallen below the bottom of the plurality of the slots at the bottom of the filter cartridge. In this manner, more water can be extracted from the bottle by utilizing the slot near the top of the filter cartridge.

Although the slot near the top of the filter cartridge enables more water to be squeezed from the bottle, the plurality of slots near the bottom of the filter cartridge introduce air into the water stream once the slots are exposed to air. This causes an unpleasant gurgling sound and slows the flow of water exiting the bottle once the water level drops beneath the slots near the bottom of the filter cartridge. Additionally, since the water flows only through the slot near the top of the filter cartridge once the water level falls below the plurality of slots near the bottom of the filter cartridge, the flow of the water is further slowed since the surface area of the slot near the top of the filter cartridge is much less than the surface area of the plurality of slots near the top of the filter cartridge.

The surface area of the slot near the top of the conventional filter cartridge is made significantly less than the surface area of the plurality of slots near the bottom of the conventional filter cartridge to cause more water to flow through the plurality of slots near the bottom of the conventional filter cartridge in an attempt to utilize more of the filter element to filter the water. However, even where such a slot configuration is used, the utilization of the filter element is still non-uniform across the length of the filter element. For example, the top and bottom ends of the filter element are utilized more than the center of the filter element. Additionally, once the water level falls below the plurality of slots near the bottom of the filter cartridge, water flows only through the slot near the top of the filter cartridge. As a result, only the top portion of the filter element located toward the flange is used to filter water once the water level falls below the plurality of slots near the bottom of the filter cartridge, thereby reducing the life of the filter due to under-utilization of certain portions of the filter element.

### SUMMARY OF THE INVENTION

Accordingly, a need exists for a portable water filter that enables more water from a bottle to be filtered and extracted from the bottle. A need also exists to filter water with reduced aeration. Additionally, a need exists for a portable water filter that more uniformly utilizes a filter element thereof. Embodiments of the present invention provide novel solutions to these needs and others as described below.

Embodiments of the present invention are directed to a portable water filter. More specifically, a portable water filter may filter water that enters through a first opening disposed toward a first end of the filter, where the water may pass through a filter element and exit the filter through a second opening disposed at or toward the first end of the filter. The first opening (e.g., including at least one hole, at least one slot, etc.) may be defined in a surface of the filter that is free of openings toward a second end of the filter. As such, when the filter is inserted into an opening or outlet of a bottle, more of the water in the bottle may be filtered and drained as the first opening in the filter is disposed toward the opening or outlet in the bottle. Additionally, since the filter housing is free of openings toward the second end, more of the water can be filtered and drained without aeration because air in the bottle cannot escape through any other openings as the water level in the bottle approaches the first opening.

Additionally, the portable water filter may enable the flow of water through the filter element to be more uniform across the length of the filter element. For example, water entering the filter housing through the first opening may flow throughout the region between the housing and the filter element before entering the filter element. The water in this region may then flow through portions of the filter element across the length thereof (e.g., responsive to a relatively uniform pressure distribution along the length of the filter element). In this manner, a larger portion of the filter element may be more uniformly utilized to filter water, thereby reducing under-utilization of certain portions of the filter element and extending the life of the portable water filter.

In one embodiment, a filter device includes a housing comprising a first end and a second end, wherein a surface of the housing defines a first opening located toward the first end of the housing, and wherein the surface is free of openings toward the second end of the housing. A filter element is operable to fit at least partially within the housing. A cover is operable to interface with the housing at the first end, wherein the cover defines a second opening, and wherein the filter element is operable to filter fluid that enters through the first opening and exits through the second opening.

In another embodiment, a fluid dispensing apparatus includes a bottle operable to contain a fluid. A filter device is operable to be at least partially inserted into the bottle, wherein the filter device includes a housing including a first end and a second end, wherein a surface of the housing defines a first opening located toward the first end of the housing, and wherein the surface is free of openings toward the second end of the housing. A filter element is operable to fit at least partially within the housing. A cover is operable to interface with the housing at the first end, wherein the cover defines a second opening, and wherein the filter element is operable to filter the fluid that enters through the first opening and exits through the second opening. The apparatus may also include a cap operable to attach to the bottle and couple the filter device to the bottle.

In yet another embodiment, a filter device includes a housing operable to accept a filter element, wherein a surface of the housing defines a first opening located toward a first end of the housing, and wherein the surface is free of openings toward a second end of the housing. A cover is operable to interface with the housing at the first end, wherein the cover defines a second opening, and wherein the cover comprises a flange operable to interface with a rim of an opening of a bottle responsive to an insertion of at least a portion of the housing inside the bottle.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows a cross-sectional view of an exemplary portable water filter device in accordance with one embodiment of the present invention.

FIG. 2 shows a cross-sectional view of an exemplary portable water filter device purging air in accordance with one embodiment of the present invention.

FIG. 3 shows a perspective component view of an exemplary portable water filter device in accordance with one embodiment of the present invention.

FIG. 4 shows a cross-sectional component view of an exemplary portable water filter device in accordance with one embodiment of the present invention.

FIG. 5A shows a first perspective component view of an exemplary fluid dispensing apparatus in accordance with one embodiment of the present invention.

FIG. 5B shows a second perspective component view of an exemplary fluid dispensing apparatus in accordance with one embodiment of the present invention.

FIG. 5C shows a third perspective component view of an exemplary fluid dispensing apparatus in accordance with one embodiment of the present invention.

FIG. 6 shows a cross-sectional view of an exemplary fluid dispensing apparatus in accordance with one embodiment of the present invention.

FIG. 7 shows a cross-sectional view of an exemplary fluid dispensing apparatus filtering and expelling water in accordance with one embodiment of the present invention.

FIG. 8 shows a cross-sectional view of an exemplary fluid dispensing apparatus allowing air to enter a bottle in accordance with one embodiment of the present invention.

FIG. 9 shows a perspective view of an exemplary portable water filter device with a plurality of holes defined therein in accordance with one embodiment of the present invention.

FIG. 10 shows a perspective view of an exemplary portable water filter device with a plurality of slots defined therein in a first arrangement in accordance with one embodiment of the present invention.

FIG. 11 shows a perspective view of an exemplary portable water filter device with a plurality of slots defined therein in a second arrangement in accordance with one embodiment of the present invention.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

### Embodiments of the Invention

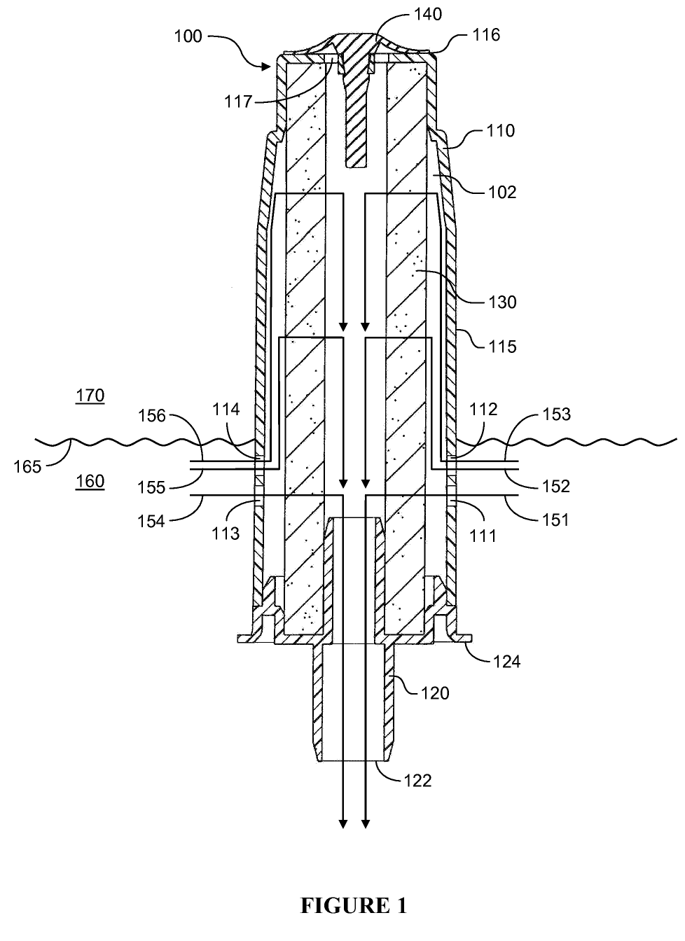

FIG. 1 shows a cross-sectional view of exemplary portable water filter device 100 in accordance with one embodiment of the present invention. As shown in FIG. 1, filter device 100 includes housing 110, cover 120 and filter element 130. Filter device 100 may filter water (e.g., 160) that enters through a first opening (e.g., 111, 112, 113, 114, some combination thereof, etc.) disposed toward a first end of filter device 100, where the water (e.g., 160) may pass through filter element 130 and exit filter device 100 through a second opening (e.g., 122) disposed at or toward the first end of filter device 100 (e.g., as shown by arrows 151, 152, 153, 154, 155, 156, some combination thereof, etc.). The first opening (e.g., 111, 112, 113, 114, some combination thereof, etc.) may be defined in a surface (e.g., 115) of filter device 100 that is free of openings toward a second end of the filter (e.g., the end opposite cover 120).

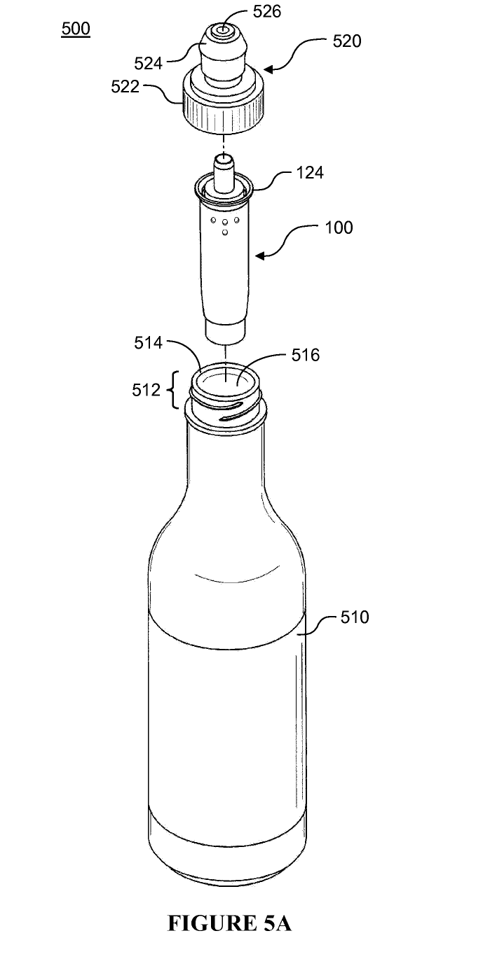

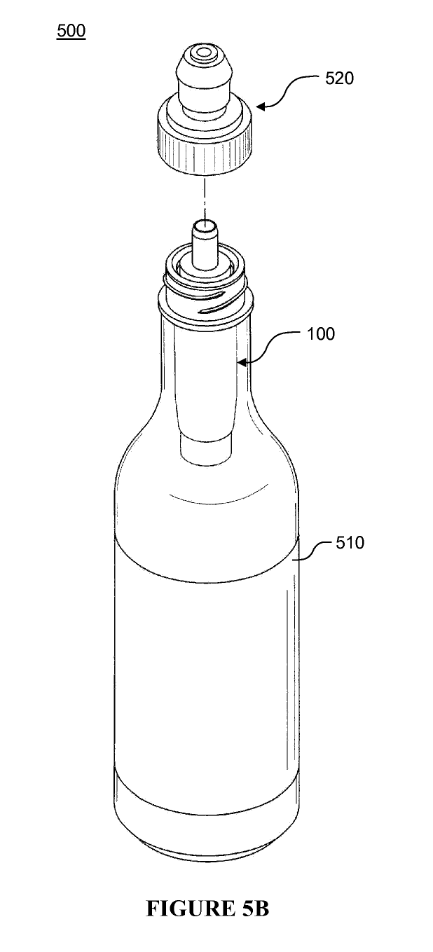

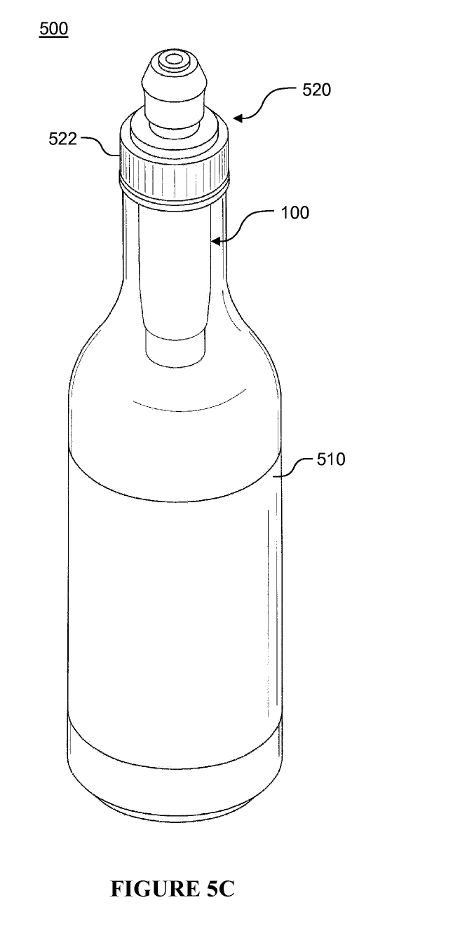

Accordingly, when filter device 100 is inserted into an opening or outlet of a container (e.g., opening 516 of bottle 510 as shown in FIGS. 5A, 5B and 5C), more of the water (e.g., 160) in the container may be filtered and drained as the first opening (e.g., 111, 112, 113, 114, some combination thereof, etc.) in filter device 100 is disposed toward the opening or outlet of the container. Additionally, since the filter housing (e.g., 110) is free of openings toward the second end, more of the water (e.g., 160) can be filtered and drained with reduced aeration because air (e.g., 170) in the container cannot escape through any other openings as the water level (e.g., 165) in the bottle approaches the first opening (e.g., 111, 112, 113, 114, some combination thereof, etc.). In this manner, water can continue to be filtered with reduced aeration as the water level (e.g., 165) moves down the filter housing from the second end toward the first opening (e.g., at a water level midway between the first and send ends of the filter device, at any other water level between the second end of the filter device and the first opening, etc.). Thus, more of the water within a bottle or other container may be filtered and drained with reduced aeration of the water, thereby enhancing the user experience by reducing the gurgling sounds and reduced water flow caused by aeration.

As shown in FIG. 1, filter device 100 may enable the flow of water through the filter element to be more uniform across the length of filter element 130 (e.g., extending from cover 120 to the end opposite cover 120). For example, water (e.g., 160) entering filter housing 110 radially through the first opening (e.g., 111, 112, 113, 114, some combination thereof, etc.) may flow axially toward the second end of the housing in region 102 (e.g., defined between housing 110 and filter element 130) before entering filter element 130. The water in this region (e.g., 102) may then flow radially through portions of filter element 130 (e.g., including at least one portion of filter element 130 disposed toward the second end of housing 110), where the flow of water through filter element 130 may be substantially uniform across the length thereof (e.g., responsive to a relatively uniform pressure distribution along the length of filter element 130 or a portion thereof). In this manner, a larger portion of filter element 130 may be more uniformly utilized to filter water, thereby reducing under-utilization of certain portions of filter element 130 and extending the life of portable water filter device 100.

Fluid flow through filter device 100 (e.g., as shown by arrows 151, 152, 153, 154, 155, 156, some combination thereof, etc.) may be driven by a pressure differential between the first opening (e.g., 111, 112, 113, 114, some combination thereof, etc.) and the second opening (e.g., 122). For example, the pressure at the first opening (e.g., 111, 112, 113, 114, some combination thereof, etc.) may be higher than the pressure at the second opening (e.g., 122), thereby driving fluid through the first opening, through filter element 130 and out the second opening. The pressure differential may be created by the squeezing of a container (e.g., bottle 510, a bottle in which filter device 100 is at least partially disposed, etc.), by a positive pressure or pump (e.g., applied to the first opening), by a vacuum (e.g., applied to the second opening), or by some other mechanism.

As shown in FIG. 1, the surface area of the first opening may be proportional to the flow rate of water flowing through filter device 100 in one embodiment. As such, the surface area of the first opening of filter device 100 may be larger than that conventional water filters. Additionally, since the first opening is defined toward the first end of the housing and since the housing is free of openings toward the second end, filter device 100 may enable water to flow through filter device 100 at a higher flow rate with reduced aeration (e.g., compared to conventional solutions) as the water level (e.g., 165) travels down the length of housing 110 toward the first opening.

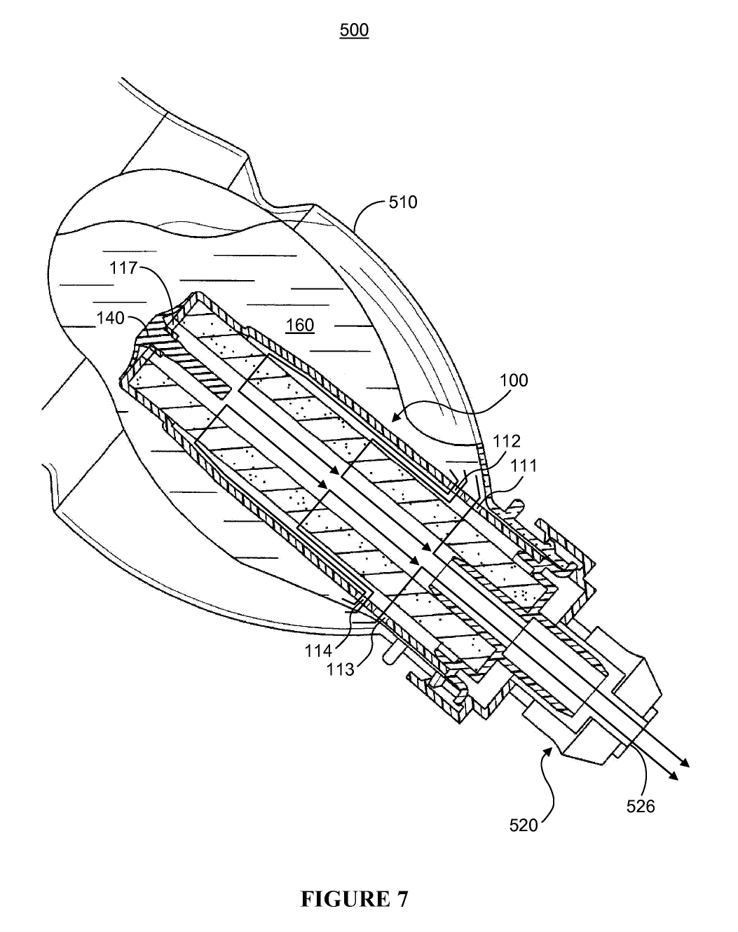

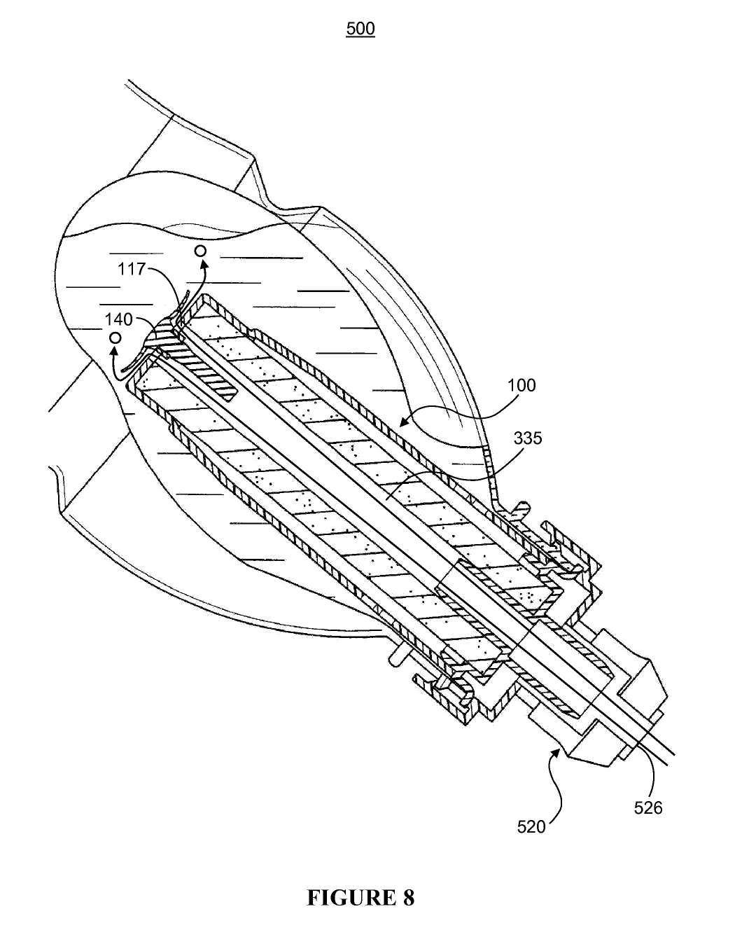

Filter device 100 may also include check valve 140. Check valve 140 may cover opening 117 defined in surface 116 of housing 110. As such, when water 160 flows through the first opening (e.g., 111, 112, 113, 114, some combination thereof, etc.), pressure acting on check valve 140 may enable check valve 140 to seal opening 117 and reduce or prevent the flow of water 160 and/or air 170 through opening 117 (e.g., as shown in FIG. 7). Additionally, when the pressure on check valve 140 is decreased (e.g., when the volume of a bottle containing filter device 100 is increased, when the volume of a bottle containing filter device 100 is allowed to return to its original shape, etc.), air entering opening 122 may flow through opening 117 past check valve 140 (e.g., as shown in FIG. 8).

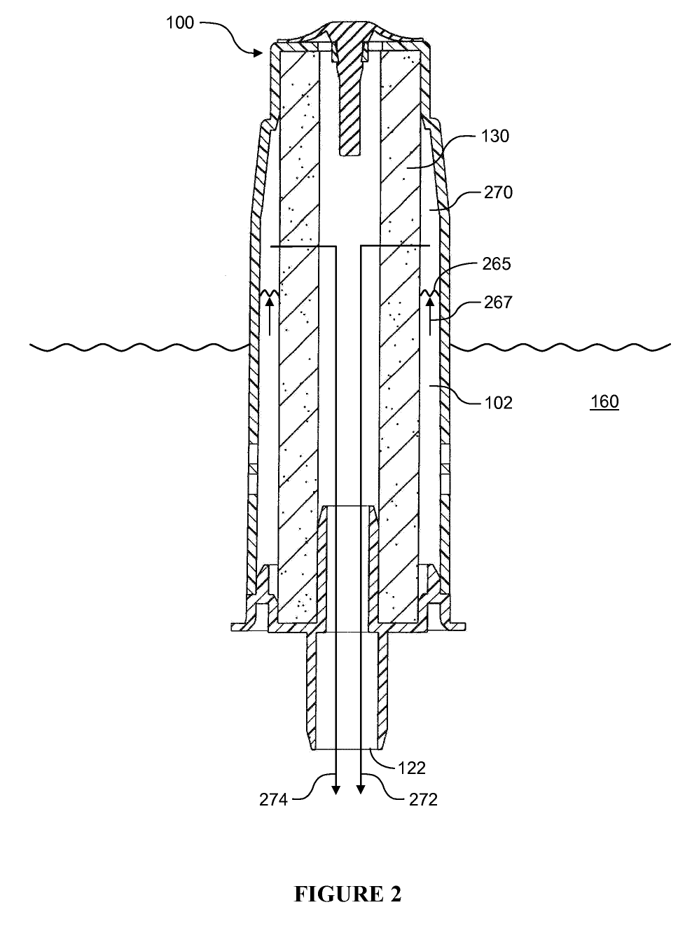

In one embodiment, filter device 100 may be configured to purge air in region 102 (e.g., entering as a result of enabling air to flow through opening 117 past check valve 140, etc.). For example, as shown in FIG. 2, water 160 may flow through the first opening (e.g., responsive to a pressure differential between the first and second openings) and cause water level 265 within region 102 to rise (e.g., as shown by arrow 267). As the water level inside region 102 rises, air (e.g., 270) may be purged (e.g., pushed through filter element 130 and out opening 122 as depicted by arrows 272 and 274). Water level 265 may rise until region 102 is completely filled with water (e.g., as shown in FIG. 1) in one embodiment. It should be appreciated that air trapped in region 102 may reduce water flow through adjacent portions of filter element 130. In this manner, air within region 102 may be advantageously purged to increase the amount of filter element 130 utilized to filter water 160 and/or increase the uniformity of utilization of filter element 130.

In one embodiment, air (e.g., 270) may flow through filter element 130 more easily than water (e.g., 160). As a result, the air (e.g., 270) may be pushed through filter element 130 before the water (e.g., 160), thereby filling region 102 with water before filtering the water within region 102. In this manner, portions of filter element 130 toward the second end (e.g., adjacent to air 270 prior to purging) can be used to filter water (e.g., 160). Thus, embodiments of the present invention enable more uniform filtration across the length of the filter media (e.g., 130) even where air makes its way into the filter device (e.g., within region 102).

In one embodiment, air 270 may be purged prior to the flow of water through filter element 130. And in one embodiment, air 270 may be purged contemporaneously with the flow of water through filter element 130 (e.g., a portion of filter element 130 toward the first end of filter device 100).

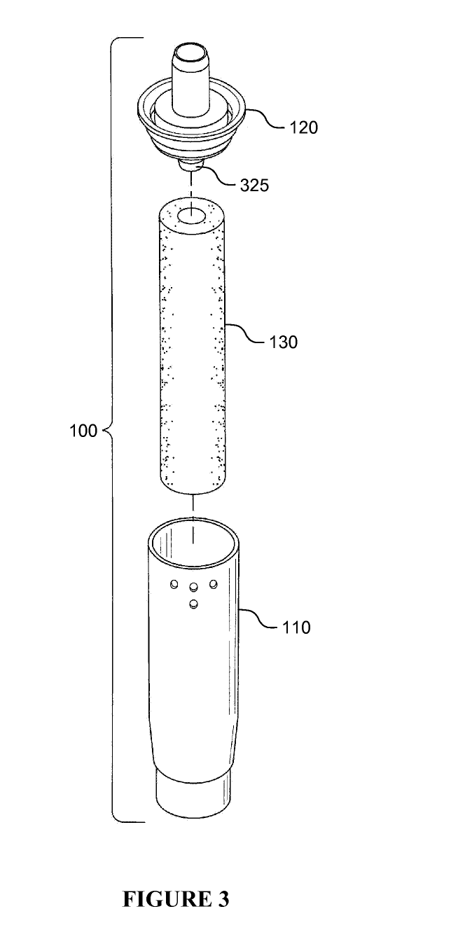

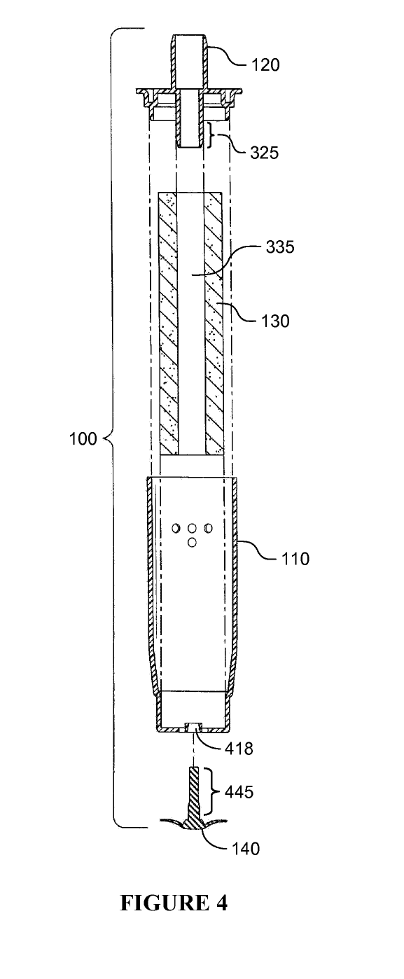

FIG. 3 shows a perspective component view of exemplary portable water filter device 100 in accordance with one embodiment of the present invention, whereas FIG. 4 shows a cross-sectional component view of exemplary portable water filter device 100 in accordance with one embodiment of the present invention. As shown in FIGS. 3 and 4, filter element 130 may be inserted into housing 110. Cover 120 may be coupled with housing 110 to at least partially enclose and/or limit movement of filter element 130 with respect to housing 110. For example, filter element 130 may be constrained in the axial direction by inner surfaces of cover 120 at the first end and housing 110 at the second end. Portion 325 of cover 120 may be inserted into region 335 of filter element 130 during assembly, thereby limiting movement of filter element 130 with respect to housing 110 in the radial direction.

In one embodiment, cover 120 and housing 110 may be secured via a press or interference fit. Cover 120 and housing 110 may be secured using respective features capable of implementing a snap fit. And in one embodiment, cover 120 and housing 110 may be secured via other mechanisms (e.g., adhesives, heat staking, ultrasonic welding, etc.).

As shown in FIG. 4, check valve 140 may be coupled with housing 110 by insertion of portion 445 of check valve 140 into opening 418 in one embodiment. Alternatively, check valve 140 may be coupled with housing 110 via another mechanism (e.g., molded or co-molded integrally with housing 110, coupled via adhesive, coupled via heat staking, coupled via ultrasonic welding, etc.).

In one embodiment, check valve 140 may be coupled with housing 110 before insertion of filter element 130 into housing 110 and/or before coupling of cover 120 and housing 110. And in one embodiment, check valve 140 may be coupled with housing 110 after insertion of filter element 130 into housing 110 and/or before coupling of cover 120 and housing 110.

Housing 110 and/or cover 120 may be made of a polymer (e.g., polypropylene, styrene acrylonitrile, etc.). In one embodiment, housing 110 and/or cover 120 may be made of a polymer that includes substantially no Bisphenol A (BPA). In one embodiment, housing 110 and/or cover 120 may be made of one or more other types of materials (e.g., stainless steel, another metal, etc.).

Filter element 130 may be composed of a carbon filter element in one embodiment. In one embodiment, filter element 130 may include approximately 38% w/w granulated active carbon with a mesh of approximately 80×325. In one embodiment, filter element 130 may include a binder made of a polymer (e.g., high-density polyethylene, another polymer, etc.), where the binder may be approximately 62% w/w of filter element 130. Alternatively, filter element 130 may be of any of a number of well known filter configurations such as a membrane filter, a pleated filter, etc.

FIGS. 5A, 5B and 5C show perspective component views of exemplary fluid dispensing apparatus 500 in accordance with one embodiment of the present invention. As shown in FIG. 5A, apparatus 500 includes filter device 100, bottle 510 and cap 520. Filter device 100 may be inserted at least partially into bottle 510 through outlet or opening 516. In one embodiment, flange 124 of filter device 100 (e.g., coupled with or formed integrally with cover 120, housing 110, or another component of filter device 100) may interface with rim 514 of bottle 510 responsive to insertion of filter device 100 into bottle 510 (e.g., as shown in FIG. 5B). First portion 522 of cap 520 may screw onto or otherwise interface (e.g., by pressing onto, snapping onto, etc.) with neck 512 of bottle 510 to couple filter device 100 with bottle 510 (e.g., as shown in FIG. 5C).

As shown in FIG. 5A, cap 520 may also include second portion 524. Second portion 524 may be movable with respect to first portion 522 in one embodiment, where movement of second portion 524 with respect to first portion 522 may vary the flow rate of fluid through cap 520. For example, if second portion 524 is pressed down against first portion 522, a seal may be formed and the flow of fluid may be reduced or prevented. As another example, fluid may flow through opening 526 in second portion 524 if second portion 524 is pulled up or away from first portion 522.

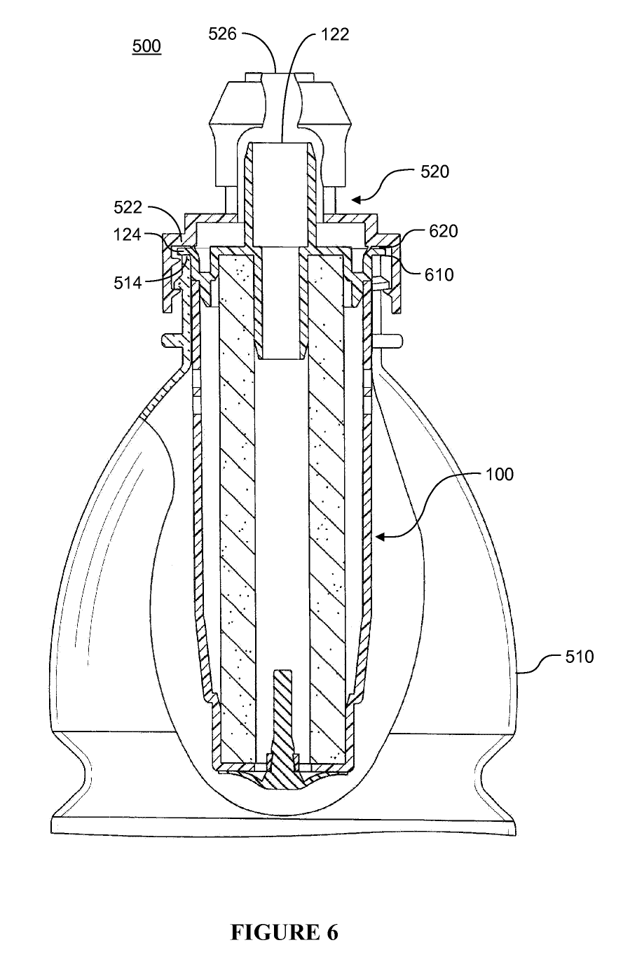

FIG. 6 shows a cross-sectional view of exemplary fluid dispensing apparatus 500 in accordance with one embodiment of the present invention. As shown in FIG. 6, at least one seal may be created by the coupling of filter device 100 to bottle 510 via cap 520. For example, first seal 610 may be formed between rim 514 of bottle 510 and a first surface of flange 124 of filter device 100. As another example, second seal 620 may be formed between cap 520 and a second surface of flange 124 of filter device 100. In this manner, bottle 510 may be pressurized (e.g., by squeezing bottle 510) to cause fluid within bottle 516 to flow through filter element 130 of filter device 100 and be expelled from bottle 510 through opening 526 in cap 520. Additionally, in one embodiment, first seal 610 and/or second seal 620 may reduce or prevent fluid from inside the bottle from flowing between rim 514, flange 124, first portion 522, or some combination thereof.

FIG. 7 shows a cross-sectional view of exemplary fluid dispensing apparatus 500 filtering and expelling water in accordance with one embodiment of the present invention. As shown in FIG. 7, water 160 entering filter device 100 through a first opening (e.g., 111, 112, 113, 114, some combination thereof, etc.) may be filtered (e.g., by filter element 130) and expelled through opening 526 of cap 520. The flow of fluid through filter device 100 may be driven by a pressure differential between the inside of the bottle and the ambient air pressure (e.g., at opening 526 of cap 520), where the pressure inside the bottle is higher than the ambient air pressure.

In one embodiment, the pressure differential causing the water to flow through filter device 100 may be created by a squeezing of the bottle. One or more seals between components of apparatus 500 (e.g., first seal 610 between rim 514 and flange 124 of filter device 100, second seal 620 between flange 124 of filter device 100 and first portion 522 of cap 520, etc.) may enable the bottle to be pressurized. Additionally, the pressure within the bottle may force check valve 140 to seal opening 117 and reduce or prevent water 160 from flowing through opening 117, thereby forcing most or all of the water that is expelled from bottle 510 to flow through the first opening (e.g., 111, 112, 113, 114, some combination thereof, etc.) instead of opening 117. As water 160 flows from the bottle, the volume of the bottle may decrease.

FIG. 8 shows a cross-sectional view of exemplary fluid dispensing apparatus 500 allowing air to enter bottle 510 in accordance with one embodiment of the present invention. As shown in FIG. 8, air entering through opening 526 in cap 520 flows through region 335 and into bottle 510 (e.g., through opening 117 and past check valve 140). The flow of air may be driven by a pressure differential between the inside of the bottle and the ambient air pressure (e.g., at opening 526 of cap 520), where the ambient air pressure is higher than the pressure inside the bottle.

In one embodiment, the pressure differential causing the air to flow into bottle 510 may be created by increasing the volume of the bottle and/or returning the bottle to its original shape. One or more seals between components of apparatus 500 (e.g., first seal 610 between rim 514 and flange 124 of filter device 100, second seal 620 between flange 124 of filter device 100 and first portion 522 of cap 520, etc.) may reduce air flow between these components and encourage the air to flow through region 335. Additionally, given that the pressure is higher within region 335 than within the bottle, the check valve 140 may be forced open and the air may be allowed to enter bottle 510 through opening 117. In this manner, embodiments of the present invention enable the bottle to be returned to its original shape more easily and quickly (e.g., to enable further pressurization of the bottle to filter and expel more water, to enable storage of the bottle, to enable refilling of the bottle, etc.) without requiring the air to be forced back through filter element 130.

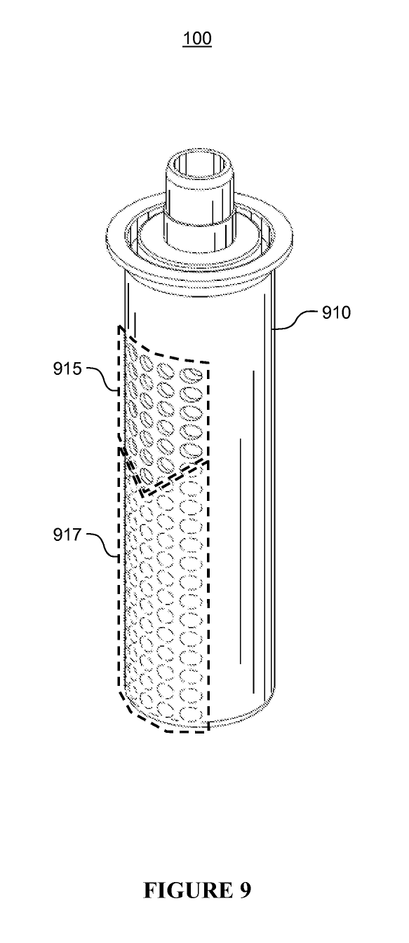

Although filter device 100 and apparatus 500 are depicted with components and/or features of a specific shape, size and arrangement, it should be appreciated that filter device 100 and/or apparatus 500 may include components and/or features of a different size, shape, arrangement, or some combination thereof. As an example, the first opening of filter device 100 may include a different number and/or arrangement of holes, slots, etc. (e.g., as shown in FIGS. 9, 10 and 11).

FIG. 9 shows a perspective view of exemplary portable water filter device 100 with a plurality of holes defined therein in accordance with one embodiment of the present invention. As shown in FIG. 9, housing 910 of filter device 100 is similar to housing 110 except that the first opening of housing 910 may include a different number and/or arrangement of holes (e.g., holes 915). In one embodiment, holes 915 may form a pattern (e.g., depicting an image, symbol, logo, etc.).

As shown in FIG. 9, housing 910 may also have defined therein features 917. Features 917 may include at least one indentation, at least one protrusion, or some combination thereof. In one embodiment, features 917 may extend only partially through housing 910, and therefore, may not allow water or air to flow into filter 110. And in one embodiment, features 917 may form a pattern (e.g., depicting an image, symbol, logo, etc.).

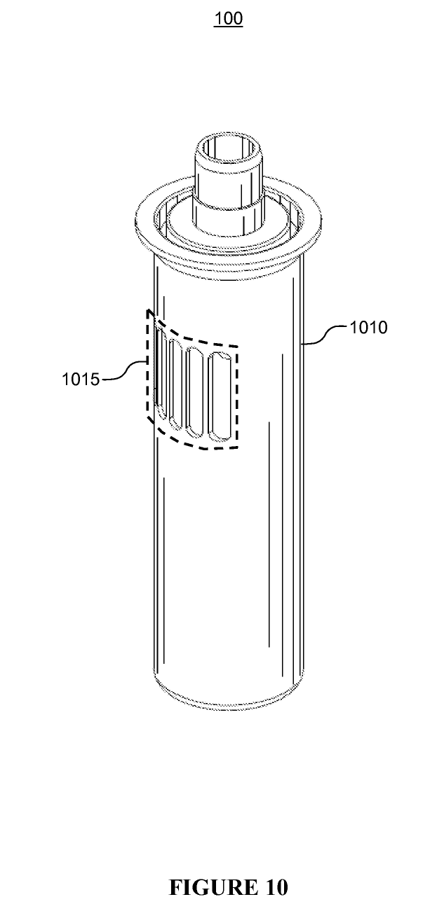

FIG. 10 shows a perspective view of exemplary portable water filter device 100 with a plurality of slots defined therein in a first arrangement in accordance with one embodiment of the present invention. As shown in FIG. 10, housing 1010 of filter device 100 is similar to housing 110 except that the first opening of housing 1010 may include at least one slot (e.g., slots 1015) instead of one or more holes. In one embodiment, slots 1015 may form a pattern (e.g., depicting an image, symbol, logo, etc.).

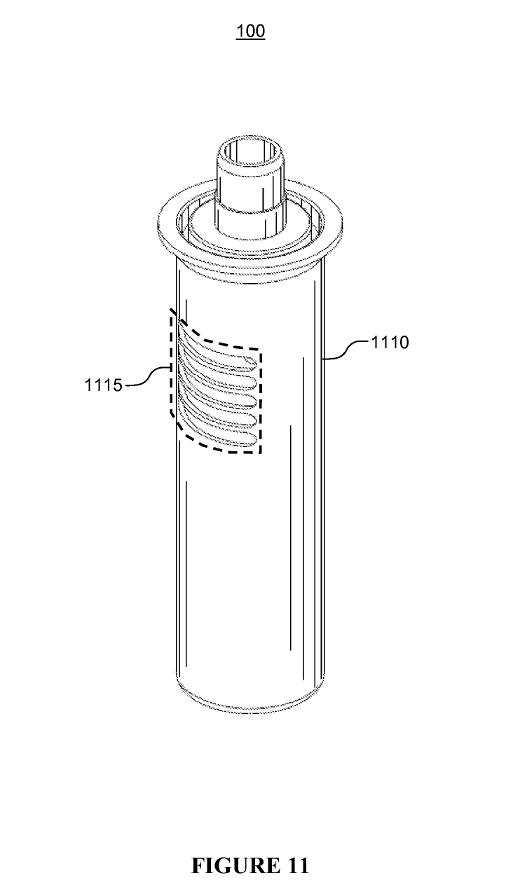

FIG. 11 shows a perspective view of exemplary portable water filter device 100 with a plurality of slots defined therein in a second arrangement in accordance with one embodiment of the present invention. As shown in FIG. 11, housing 1110 of filter device 100 is similar to housing 110 except that the first opening of housing 1110 may include at least one slot (e.g., slots 1115) instead of one or more holes. In one embodiment, slots 1115 may form a pattern (e.g., depicting an image, symbol, logo, etc.).

In one embodiment, slots 1115 depicted in FIG. 11 may be arranged differently from slots 1015 depicted in FIG. 10. For example, slots 1115 may extend along the circumference of housing 1110 whereas slots 1015 extend along the length of housing 1010.

In the foregoing specification, embodiments of the invention have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A filter device comprising:
a housing comprising a first end and a second end, wherein a surface of said housing defines a first opening located toward said first end of said housing, and wherein said surface is free of openings toward said second end of said housing;
a filter element operable to fit at least partially within said housing; and
a cover operable to interface with said housing at said first end, wherein said cover defines a second opening, and
wherein said filter element is operable to filter fluid that enters through said first opening and exits through said second opening.

2. The filter device of claim 1, wherein said housing is operable to enable said fluid to flow with reduced aeration responsive to a water level at a portion of said housing between said second end and said first opening.

3. The filter device of claim 1, wherein said housing is operable to enable said fluid to flow axially toward said second end in a region defined between said housing and said filter element.

4. The filter device of claim 1, wherein said housing is operable to enable said fluid to flow radially through a portion of said filter element disposed toward said second end of said housing.

5. The filter device of claim 1, wherein said first opening is selected from a group consisting of at least one circular hole and at least one slot.

6. The filter device of claim 1, wherein said cover comprises a flange, wherein said flange is operable to interface with a rim of an opening of a bottle responsive to an insertion of at least a portion of said housing inside said bottle, and wherein said flange is further operable to be coupled with said bottle responsive to a coupling of a cap with said bottle.

7. The filter device of claim 6, wherein said flange is operable to form a seal between said rim of said bottle and said cap.

8. The filter device of claim 1, wherein another surface of said housing defines a third opening at said second end, and further comprising:
a check valve coupled with said housing, wherein said check valve enables air to enter through said second opening and exit through said third opening, and wherein said check valve is further operable to limit fluid flow into said housing through said third opening.

9. A fluid dispensing apparatus comprising:
a bottle operable to contain a fluid;
a filter device operable to be at least partially inserted into said bottle, wherein said filter device comprises:
a housing comprising a first end and a second end, wherein a surface of said housing defines a first opening located toward said first end of said housing, and wherein said surface is free of openings toward said second end of said housing;
a filter element operable to fit at least partially within said housing; and
a cover operable to interface with said housing at said first end, wherein said cover defines a second opening, and
wherein said filter element is operable to filter said fluid that enters through said first opening and exits through said second opening; and
a cap operable to attach to said bottle and couple said filter device to said bottle.

10. The apparatus of claim 9, wherein said housing is operable to enable said fluid to flow with reduced aeration responsive to a water level at a portion of said housing between said second end and said first opening.

11. The apparatus of claim 9, wherein said housing is operable to enable said fluid to flow axially toward said second end in a region defined between said housing and said filter element.

12. The apparatus of claim 9, wherein said housing is operable to enable said fluid to flow radially through a portion of said filter element disposed toward said second end of said housing.

13. The apparatus of claim 9, wherein said first opening is selected from a group consisting of at least one circular hole and at least one slot.

14. The apparatus of claim 9, wherein said cover comprises a flange, wherein said bottle defines a third opening, wherein said flange is operable to interface with a rim of said third opening responsive to an insertion of at least a portion of said housing inside said bottle.

15. The apparatus of claim 14, wherein said flange is operable to form a seal between said rim of said bottle and said cap.

16. The apparatus of claim 9, wherein said cap defines a fourth opening fluidly coupled with said second opening of said cover.

17. The apparatus of claim 9, wherein another surface of said housing further defines a fifth opening at said second end, and wherein said filter device further comprises:
a check valve coupled with said housing, wherein said check valve enables air to enter through said second opening and exit through said fifth opening, and wherein said check valve is further operable to limit fluid flow into said housing through said fifth opening.

18. A filter device comprising:
a housing operable to accept a filter element, wherein a surface of said housing defines a first opening located toward a first end of said housing, and wherein said surface is free of openings toward a second end of said housing; and
a cover operable to interface with said housing at said first end, wherein said cover defines a second opening, and wherein said cover comprises a flange operable to interface with a rim of an opening of a bottle responsive to an insertion of at least a portion of said housing inside said bottle.

19. The filter device of claim 18, wherein said housing is operable to enable said fluid to flow with reduced aeration responsive to a water level at a portion of said housing between said second end and said first opening.

20. The filter device of claim 18, wherein said filter element is operable to filter fluid that enters through said first opening and exits through said second opening.

21. The filter device of claim 18, wherein said housing is operable to enable said fluid to flow axially toward said second end in a region defined between said housing and said filter element.

22. The filter device of claim 18, wherein said housing is operable to enable said fluid to flow radially through a portion of said filter element disposed toward said second end of said housing.

23. The filter device of claim 18, wherein said first opening is selected from a group consisting of at least one circular hole and at least one slot.

24. The filter device of claim 18, wherein said flange is further operable to be coupled with said bottle responsive to a coupling of a cap with said bottle.

25. The filter device of claim 18, wherein said flange is operable to form a seal between said rim of said bottle and said cap.

26. The filter device of claim 18, wherein another surface of said housing defines a third opening at said second end, and further comprising:
a check valve coupled with said housing, wherein said check valve enables air to enter through said second opening and exit through said third opening, and wherein said check valve is further operable to limit fluid flow into said housing through said third opening.
